(19) United States
(12) Patent Application Publication
(10) Pub. No.: US 2007/0284866 A1
(43) Pub. Date: Dec. 13, 2007

(54) Work vehicle outrigger and associated method

(75) Inventor: Rex Allen Hanson, Peosta, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/448,498

(22) Filed: Jun. 7, 2006

(51) Int. Cl. B60S 9/02

(52) U.S. Cl. 280/763.1

(57) ABSTRACT

An outrigger is configured for use in stabilizing a work vehicle. The outrigger comprises a foldable stabilizer arm that folds and unfolds upon movement between stowage and deployed positions.

### FIELD OF THE DISCLOSURE

The present disclosure relates to work vehicle outriggers and associated methods.

### BACKGROUND OF THE DISCLOSURE

Outrigging is used to stabilize a work vehicle during a work operation. Typically, such outrigging includes a pair of outriggers located on opposite sides of a tractor of the vehicle. When deployed, the outriggers support the work vehicle, providing improved stability for the work operation.

### SUMMARY OF THE DISCLOSURE

According to the present disclosure, an outrigger is provided for use with a work vehicle to facilitate stabilization of the work vehicle during a work operation. A foldable stabilizer arm of the outrigger is adapted for attachment to a tractor of the work vehicle for pivotal movement relative to the tractor between stowage and deployed positions. The foldable stabilizer arm comprises inboard and outboard arm segments that are pivotable relative to the tractor and fold and unfold relative to one another upon movement of the foldable stabilizer arm between the stowage and deployed positions. Such foldable movement of the stabilizer arm minimizes the lateral clearance needed for deployment of the outrigger. Further, the outrigger is designed in a manner so as to promote the laterally stability of the work vehicle. An associated method is disclosed.

Illustratively, the inboard arm segment comprises a four-bar linkage. The four-bar linkage is pivotally attached to the tractor and to the outboard arm segment. In response to operation of an arm actuator, the foot moves in a foot path between the stowage and deployed positions, the foot path being non-circular about an inboard end of the foldable stabilizer arm, minimizing the side clearance needed for deployment of the outrigger. In such an arrangement, the overall distance between the foot and the inboard end is greater in the deployed position than in the stowage position. Moreover, the lateral distance between the foot and the inboard end is also greater, promoting the lateral stability of the work vehicle.

Exemplarily, the arm actuator is a linear actuator such as a hydraulic cylinder. In such a case, the linear actuator is attached at one end to one of the inboard pivots of the four-bar linkage and at an opposite end to one of the outboard pivots of the four-bar linkage.

The above and other features will become apparent from the following description and the attached drawings.

### BRIEF DESCRIPTION OF THE DRAWINGS

The detailed description of the drawings refers to the accompanying figures in which:

FIG. 1 is a perspective view of a work vehicle exemplarily in the form of a backhoe loader;

FIG. 2 is a side elevation view of a tractor-mounted outrigger in a stowage position;

FIG. 3 is a side elevation view of the outrigger in an intermediate position between the stowage position of FIG. 2 and a deployed position of FIG. 4; and

FIG. 4 is a side elevation view of the outrigger in the deployed position.

### DETAILED DESCRIPTION OF THE DRAWINGS

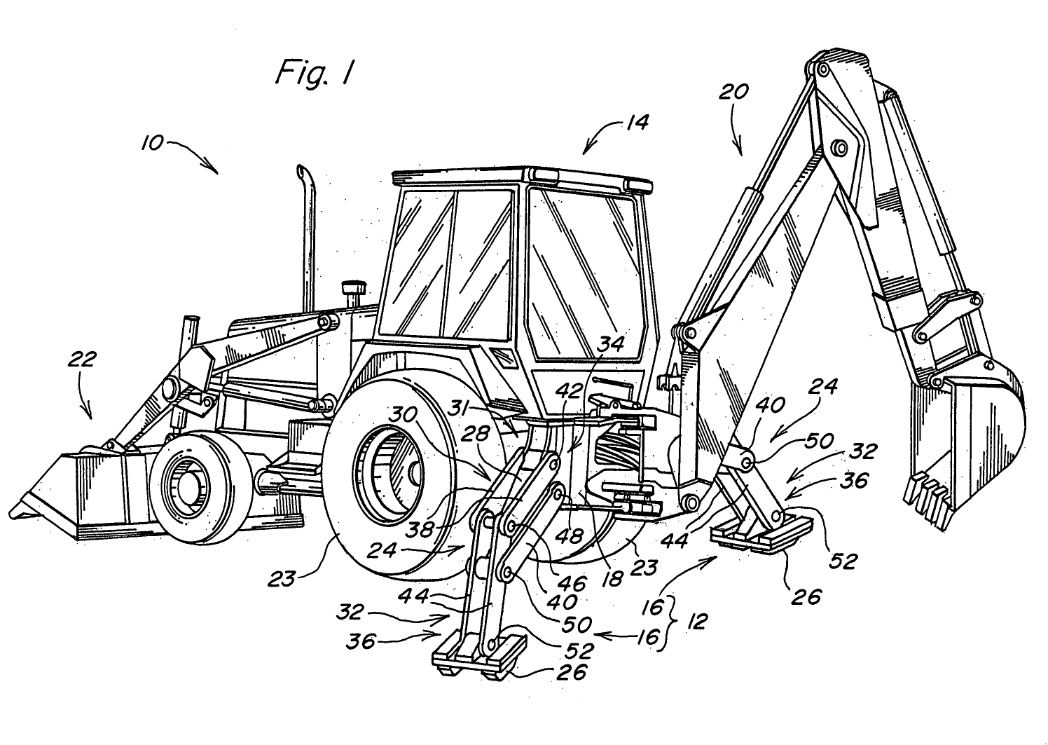

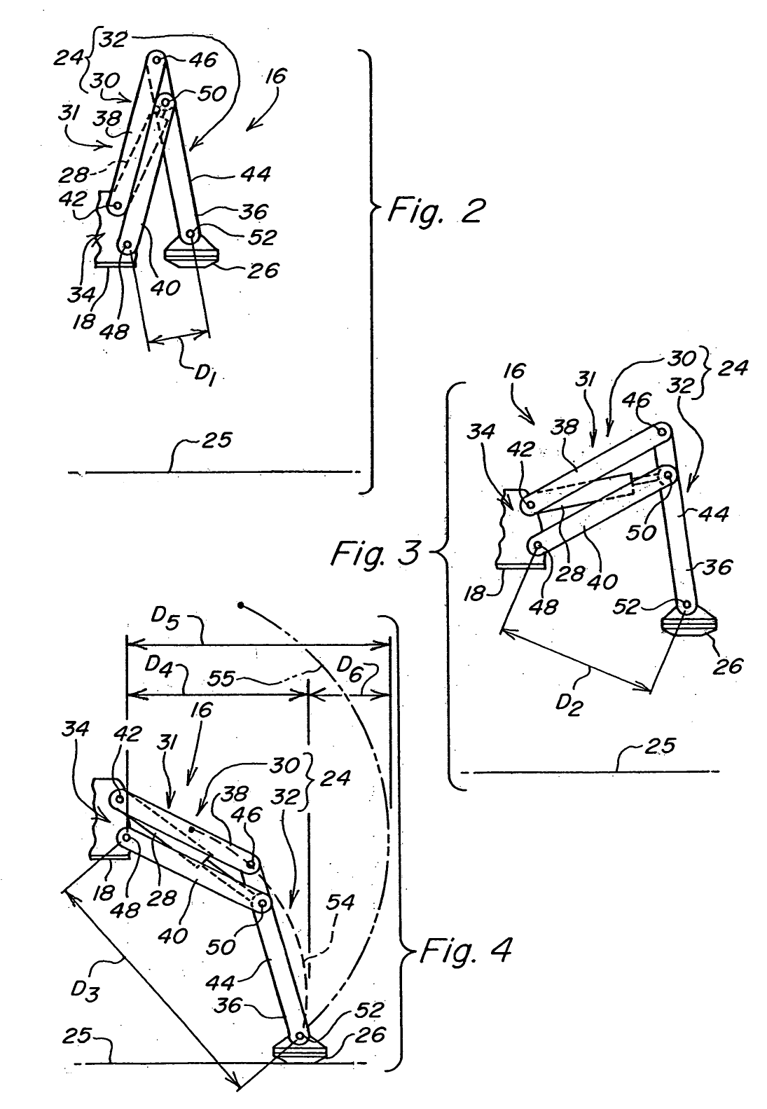

A work vehicle 10 shown in FIG. 1 comprises outrigging 12 for stabilizing the work vehicle 10 during a work operation. The outrigging 12 comprises a pair of outriggers 16 pivotally attached to opposite sides of a tractor 14 of the work vehicle 10. The outriggers 16 are movable between a stowage position (see FIG. 2) for stowage of the outriggers 16 during periods of non-use and a vehicle stabilizing deployed position (see FIGS. 1 and 4). Each outrigger 16 is designed to minimize the lateral clearance needed for its deployment and is designed to promote lateral stability of the vehicle 10.

In the illustrated example, the vehicle 10 is shown as a backhoe loader. In such a case, the outrigging 12 is attached to a frame 18 of the tractor 14 at a rear portion thereof for use in conjunction with a rear-mounted backhoe 20 opposite a front-mounted loader 22. In this configuration, to prepare for a work operation of the backhoe 20 (e.g., digging, material handling), the vehicle operator deploys the outriggers 16 to their deployed position to lift or otherwise support the rear portion of the tractor 14 which may thus raise the rear wheels 23 off the ground 25. Once in this position, the vehicle 10 is ready for use of the backhoe 20. When the operator is finished with the backhoe, the operator causes the outriggers 16 to retract to their stowage position next to the frame 18.

In the Illustrated embodiment, the outriggers 16 are similar in structure and function to one another. As such, the following description of one outrigger 16 applies to the other as well.

The outrigger 16 has a foldable stabilizer arm 24, a foot 26, and an arm actuator 28. The foldable stabilizer arm 24 moves the foot 26 between the stowage and deployed positions in response to operation of the arm actuator 28. Exemplarily, the arm actuator 28 is a linear actuator in the form of, for example, a hydraulic cylinder. Illustratively, the barrel of the hydraulic cylinder is attached inboard of the rod, although it is to be understood that the orientation of the hydraulic cylinder could be reversed.

The foldable stabilizer arm 24 is configured for foldable movement so as to retract and extend between the stowage and deployed positions. Illustratively, it is configured as a linkage comprising an inboard arm segment 30 and an outboard arm segment 32 outboard of and pivoted to the inboard arm segment 30. The inboard arm segment 30 provides an inboard end 34 of the arm 24, the inboard end 34 being pivoted to the frame 18. The outboard arm segment 32 provides an outboard end 36 of the arm 24, the foot 26 being pivoted to the outboard end 36. As such, the inboard and outboard arm segments 30, 32 pivot relative to the tractor 14 and fold and unfold relative to one another upon movement of the arm 24 between the stowage and deployed positions. In the stowage position, the segments 30, 32 are folded relative to one another such that the outrigger 16 is relatively compact. In the deployed position, the segments 30, 32 are unfolded relative to one another so as to present a relatively wide, and thus firm, base for support of the tractor 14.

The inboard arm segment 30 comprises a four-bar linkage 31 pivoted to the frame 18 and the outboard arm segment 32. The four-bar linkage includes a pair of upper bars 38 and a pair of lower bars 40. Depending on the performance characteristics desired or other factors, the upper and lower bars 38, 40 may be parallel or non-parallel to one another. Further, although the bars 38 are illustrated as being separate, individual links, they could be formed as a single component by welding, casting, or other suitable process. The same comment applies also to the bars 40.

Inboard ends of the upper bars 38 are attached to the frame 18 at an upper inboard pivot 42 and outboard ends of the upper bars 38 are attached to a pair of bars 44 of the outboard arm segment 32 at an upper outboard pivot 46. Inboard ends of the lower bars 40 are attached to the frame 18 at a lower inboard pivot 48 and outboard ends of the lower bars 40 are attached to the bars 44 of the outboard arm segment 32 at a lower outboard pivot 50. The foot 26 is attached to the two bars 44 at a pivot 52. Although the bars 44 are illustrated as being separate, individual links, they could be formed as a single component by welding, casting, or other suitable process.

The opposite ends of the arm actuator 28 may be mounted in a variety of ways. As such, the arm actuator ends may be separate from or attached to any of pivots 42, 46, 48, or 50. Illustratively, the opposite ends of the arm actuator 28 are attached to the pivots 42 and 50, providing cost benefits.

The four-bar linkage 31 acts to extend and retract the bars 44 of the outboard arm segment 32, as shown in FIGS. 2-4. As such, the foot 26 moves in a foot path 54 between the stowage and deployed positions. The foot path 54 is non-circular about the inboard end 34 and, in particular, about the pivot 48. It is non-circular about this attachment point in the sense that, instead of remaining at a constant radius, the distance defined between this attachment point and the foot 26 varies as the foot 26 moves between the stowage and deployed positions. D₁ represents the distance in the stowage position, as shown in FIG. 2. D₂ represents the distance at an intermediate position between the stowage and deployed positions as shown in FIG. 3. D₃ represents the distance in the deployed position, as shown in FIG. 4. As can be seen in FIGS. 24, D₃ is greater than D₂ and even greater than D₁. As such, the foot 26 is farther away from the inboard end 34 in the deployed position than in the stowage position.

A benefit of the foot path 54 is that the outrigger 16 does not need as much lateral clearance as, say, a radial swing arm that swings its associated foot about the pivot 48 along an circular foot path 55 having a constant radius equal to the distance D₃ as shown, for example, in FIG. 4 (the term “lateral clearance” means the distance between the attachment point of the outrigger 16 to the tractor 14 and the laterally outermost point on the respective foot path). In particular, the lateral clearance D₄ associated with the outrigger 16 is smaller than the lateral clearance D₅ needed by the radial swing arm, resulting in lateral clearance decrease of D₆ (i.e., D₅ minus D₄) for the outrigger 16 or 2D₆ if there are two outriggers 16 employed on opposite sides of the tractor. This smaller lateral clearance thus allows use of the outrigger 16 in more narrow areas where there may be walls or other lateral restrictions that would otherwise preclude deployment of a radial swing arm outrigger.

Further, the foot 26 is positioned laterally outwardly from the inboard end 34 in the deployed position. Such laterally outward positioning of the foot 26 promotes the lateral stability of the vehicle 10. The outrigger 16 thus provides not only enhanced lateral clearance but also lateral stability.

The bars 38, 40, and 44 could be provided with multiple alternative holes for selective mounting of the associated pivots 42, 46, 48, and 50. In this way, the foot path can be selectively adjusted. As alluded to above, the bars 38 could be joined (e.g., welding) or casted as a single component to, for example, facilitate manufacturing and/or assembly. This same comment applies also to bars 40 and bars 44.

Illustratively, the point 52 is located on both the foot path 54 and the foot path 55 in the deployed position, providing lift and stability equal to the radial swing arm. It is to be understood that the outrigger 16 may be designed such that the point 52 may be separate from the path 55 in the deployed position (e.g., slightly higher or lower than the path 55), thereby modifying the lift and stability characteristics of the outrigger 16 relative to the radial swing arm. Exemplarily, the deployed position of point 52 may be established such that the outrigger 16 provides equal lift with more stability or equal stability with more lift.

While the disclosure has been illustrated and described in detail in the drawings and foregoing description, such an illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. An outrigger for use in stabilizing a work vehicle, the outrigger comprising a foldable stabilizer arm adapted for attachment to a tractor of the work vehicle for pivotal movement relative to the tractor between stowage and deployed positions, the foldable stabilizer arm comprising inboard and outboard arm segments that are pivotable relative to the tractor and fold and unfold relative to one another upon movement of the foldable stabilizer arm between the stowage and deployed positions.

2. The outrigger of claim 1, wherein the inboard arm segment comprises a four-bar linkage.

3. The outrigger of claim 2, wherein the four-bar linkage is pivotally attachable to the tractor and is pivotally attached to the outboard arm segment.

4. The outrigger of claim 3, further comprising a foot attached to the outboard arm segment.

5. The outrigger of claim 2, wherein the four-bar linkage comprises a pair of parallel upper bars and a pair of parallel lower bars, the upper bars are attached to an inboard upper pivot at inboard ends of the upper bars and an outboard upper pivot at outboard ends of the upper bars, and the lower bars are attached to an inboard lower pivot at inboard ends of the lowers bars and an outboard lower pivot at outboard ends of the lower bars.

6. The outrigger of claim 5, wherein the outboard arm segment comprises a pair of parallel bars pivotally attached to the outboard upper and lower pivots.

7. The outrigger of claim 6, comprising a foot attached to the two bars of the outboard arm segment.

8. The outrigger of claim 5, comprising a hydraulic cylinder extending between the inboard upper pivot and the outboard lower pivot.

9. The outrigger of claim 1, comprising a foot, wherein the foldable stabilizer arm comprises an inboard end pivotally attachable to the tractor, and the foot is farther away from the inboard end in the deployed position than in the stowage position.

10. The outrigger of claim 1, comprising an arm actuator attached to the outboard arm segment.

11. The outrigger of claim 1, comprising a foot, wherein the inboard arm segment provides an inboard end of the foldable stabilizer arm, the inboard end is attachable to the tractor for pivotable movement relative thereto, the outboard arm segment provides an outboard end of the foldable stabilizer arm, the foot is attached to the outboard arm segment and is arranged to be outboard of the inboard end in the deployed position.

12. A work vehicle, comprising:
a tractor, and an outrigger comprising a foot, an arm actuator, and a foldable stabilizer arm that is pivotally attached to the tractor at an inboard end of the foldable stabilizer arm, is attached to the foot at an outboard end of the foldable stabilizer arm, and is movable between stowage and deployed positions in response to operation of the arm actuator, the foldable stabilizer arm comprising a four-bar linkage.

13. The work vehicle of claim 12, wherein the work vehicle comprises a backhoe.

14. The work vehicle of claim 12, wherein the four-bar linkage is pivotally attached to the tractor and pivotally attached to an outboard arm segment of the foldable stabilizer arm extending between the four-bar linkage and the foot.

15. The work vehicle of claim 12, wherein the foot is farther away from the inboard end in the deployed position than in the stowage position and laterally outward from the inboard end in the deployed position.

16. The work vehicle of claim 12, wherein the foldable stabilizer arm comprises an outboard arm segment extending between the four-bar linkage and the foot, and the arm actuator comprises a hydraulic cylinder extending between the tractor and the outboard arm segment.

17. A method of stabilizing a work vehicle with an outrigger, the outrigger comprising a foldable stabilizer arm comprising multiple segments disposed along a length of the foldable stabilizer arm, the method comprising pivoting the multiple segments of the foldable stabilizer arm relative to one another and laterally outwardly relative to a tractor of the work vehicle from a stowage position to a deployed position.

18. The method of claim 17, wherein one of the segments of the foldable stabilizer arm comprises a four-bar linkage, and the pivoting comprises pivoting the four-bar linkage.

19. The method of claim 18, wherein the foldable stabilizer arm comprises a second segment extending between the four-bar linkage and a foot of the outrigger, and the pivoting comprises moving the second segment with a hydraulic cylinder extending between the tractor and the second segment.

20. The method of claim 17, wherein the foldable stabilizer arm is pivoted to the tractor at an attachment point, the pivoting comprises moving a foot of the outrigger in a foot path between the stowage and deployed positions, the foot path being non-circular relative to the attachment point.
